(19) United States
(12) Patent Application Publication
(10) Pub. No.: US 2014/0158484 A1
(43) Pub. Date: Jun. 12, 2014

(54) Brake Hub Having Radial Apertures

(71) Applicant: Ian Leonard MACDONALD, Hoffman Estates, IL (US)

(72) Inventor: Ian Leonard MACDONALD, Hoffman Estates, IL (US)

(21) Appl. No.: 13/712,350

(22) Filed: Dec. 12, 2012

(51) Int. Cl. F16D 65/853; F16D 65/12

(52) U.S. Cl. CPC F16D 65/853; F16D 65/123; F16D 65/128
USPC 188/18 A; 188/218 R; 74/607

(57) ABSTRACT

A brake hub is disclosed. The brake hub may include a cylindrical body portion, and a rim extending from an outer edge of the cylindrical body portion. The rim may include a plurality of first splines disposed on an outer annular surface of the rim. Each of the plurality of first splines may extend from a first end of the rim to a second end of the rim. The rim may also include a plurality of radial apertures in the rim extending from the first end of the rim toward the second end of the rim, and a plurality of second splines disposed on the outer annular surface of the rim. Each of the plurality of second splines may extend from an edge of one of the plurality of radial apertures to the second end of the rim. The brake hub may also include a mounting flange protruding from the cylindrical body portion.

### TECHNICAL FIELD

The present disclosure is directed to a brake hub and, more particularly, to a brake hub having radial apertures.

### BACKGROUND

Machines, including on and off-highway haul and vocational trucks, wheel loaders, motor graders, and other types of heavy equipment generally include an oil-cooled hydraulic braking system. In an oil-cooled hydraulic braking system, multiple brake disks are placed over a brake hub and wheel axle, and spacer plates are placed between each brake disk. Hydraulic oil runs through the brake system and in between the alternating brake disks and spacer plates. The oil creates a film on the brake disks and spacer plates, helping to prevent direct contact between the compressed rotating surfaces and extend brake life. The hydraulic oil also serves to cool the braking system. Standard brake hubs may trap oil and heat, preventing adequate cooling of their associated components.

An exemplary hub is described in U.S. Pat. No. 6,779,642 (“the '642 patent”) of Arai et al. that issued on Aug. 24, 2004. The '642 patent describes a hub having lubricating oil passages disposed on an outer circumference of the hub. The passages of the '642 patent scatter oil radially outward by centrifugal force, thereby improving oil circulation and cooling.

Although the system of the '642 patent may be capable of improving circulating and cooling in a hub assembly, it may still be suboptimal. First, because the lubricating oil passages are provided on a periphery of the hub, the hub may have reduced durability. Second, pressure buildup within the system may trap oil around the clutch hub, preventing the system from adequately cooling in all applications.

The brake hub of the present disclosure solves one or more of the problems set forth above and/or other problems of the prior art.

### SUMMARY

One aspect of the present disclosure is directed to a brake hub. The brake hub may include a cylindrical body portion, and a rim extending from an outer edge of the cylindrical body portion. The rim may include a plurality of first splines disposed on an outer annular surface of the rim. Each of the plurality of first splines may extend from a first end of the rim to a second end of the rim. The rim may also include a plurality of radial apertures in the rim extending from the first end of the rim toward the second end of the rim, and a plurality of second splines disposed on the outer annular surface of the rim. Each of the plurality of second splines may extend from an edge of one of the plurality of radial apertures to the second end of the rim. The brake hub may also include a mounting flange protruding from the cylindrical body portion.

Another aspect of the present disclosure is directed to a leg housing. The leg housing may include a body portion having a first end and a second end, and a flange disposed at the first end. The flange may include a first conduit extending from an outer surface of the flange toward an interior volume of the body portion. The first conduit may be disposed approximately at an assembled two o'clock position of the flange. The flange may also include a second conduit extending from the outer surface of the flange toward the interior volume of the body portion. The second conduit may be disposed approximately at an assembled ten o'clock position of the flange. The flange may also include a third conduit formed in an assembled gravitational lower half of the flange.

### BRIEF DESCRIPTION OF THE DRAWINGS

FIG. 1 is a pictorial illustration of an exemplary disclosed drive assembly;

FIG. 2 is a cross-sectional illustration of the drive assembly of FIG. 1;

FIG. 3 is an enlarged cross-sectional illustration of a portion of the drive assembly of FIG. 2;

FIG. 4 is a pictorial illustration of an exemplary disclosed brake hub of FIG. 4;

FIG. 5 is another pictorial illustration of the exemplary disclosed brake hub that may be used in conjunction with the drive assembly of FIG. 2;

FIG. 6 is a cross-sectional illustration taken along line B-B of the brake hub of FIG. 5; and

FIG. 7 is a cross-sectional illustration taken along line B-B of an alternative embodiment of the brake hub of FIG. 5.

### DETAILED DESCRIPTION

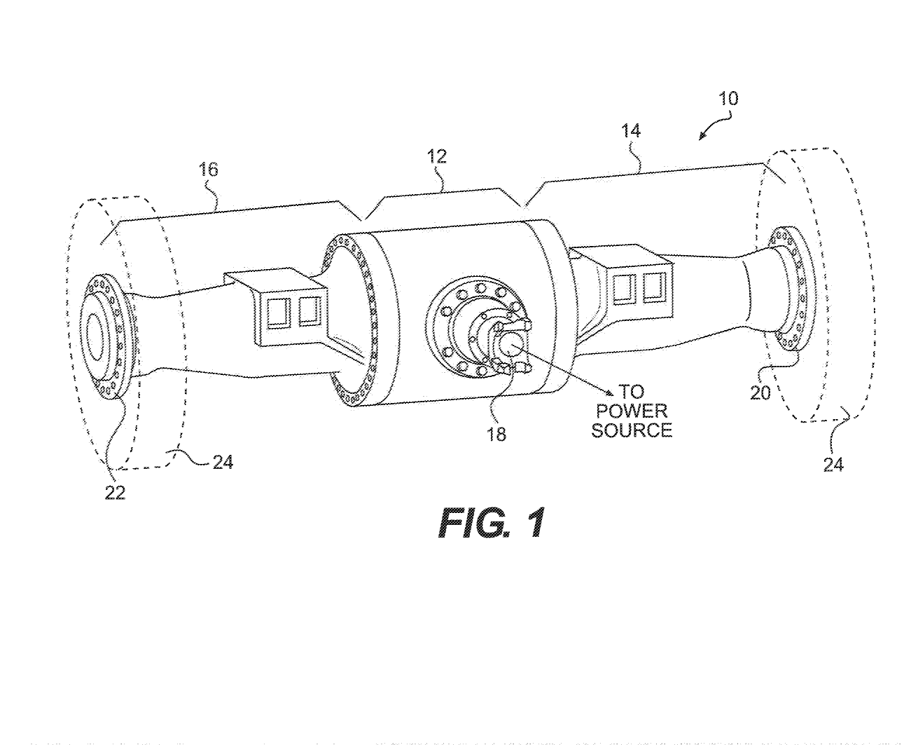

FIG. 1 illustrates an exemplary disclosed drive assembly 10. Drive assembly 10 may be associated with a mobile vehicle (not shown) so as to propel the vehicle. As such, drive assembly 10 may include a differential assembly 12 and first and second final drive assemblies 14, 16. An input member such as a driveshaft 18 may drivingly connect a power source (e.g., an engine and transmission, both of which are not shown) of the vehicle to differential assembly 12. Two output members such as a first output shaft 20 and a second output shaft 22 may drivingly connect final drive assemblies 14, 16 to traction devices 24 located on opposing sides of the vehicle. In one embodiment, traction devices 24 may embody wheels. Final drive assemblies 14, 16, may be drivingly coupled to differential assembly 12 such that a rotation of driveshaft 18 results in a corresponding rotation of output shafts 20, 22 and traction devices 24.

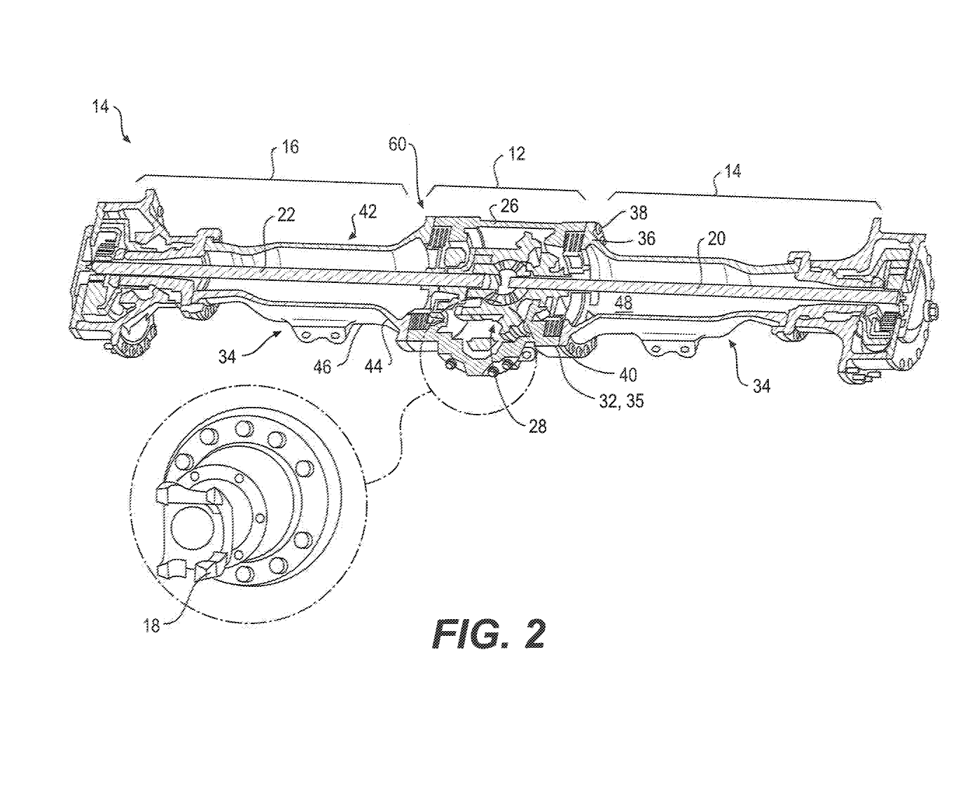

As illustrated in FIG. 2, differential assembly 12 may include a center housing 26 and a differential gear arrangement 28 supported within center housing 26. Center housing 26 may be a generally cylindrical housing having an axial direction substantially aligned with output shafts 20, 22. One or more bearings may be located within center housing 26 to support the rotation of output shafts 20, 22. Driveshaft 18 may extend through a side of center housing 26 to engage and rotationally drive differential gear arrangement 28. In turn, differential gear arrangement 28 may operatively engage and transfer the input rotation of driveshaft 18 to output shafts 20, 22. At each opposing end of center housing 26, an end face 32 may be located to engage and seal against a leg housing 34 of final drive assemblies 14, 16 (i.e., final drive assemblies 14 and 16 may have associated leg housings 34 that are substantially identical to each other). Specifically, end face 32 of center housing 26 may abut an end face 35 of each leg housing 34. A sealing element such as, for example, a gasket (not shown) may be inserted between end faces 32 and 35 of center and leg housings 26, 34, if desired, to improve fluid sealing at that interface. End face 35 may be part of a mounting flange 36.

Leg housing 34 of each final drive assembly 14, 16 may enclose and support a planetary gear arrangement and an associated one of output shafts 20, 22. Leg housing 34 may be connected to center housing 26 by way of, for example, threaded fasteners 38 located around an outer rim 40 of mounting flange 36. Leg housing 34 may include a body portion 42 that is integral with mounting flange 36. Body portion 42 may include a conical portion 44 and a cylindrical portion 46. Conical portion 44 and cylindrical portion 46 may define an interior volume 48 of leg housing 34.

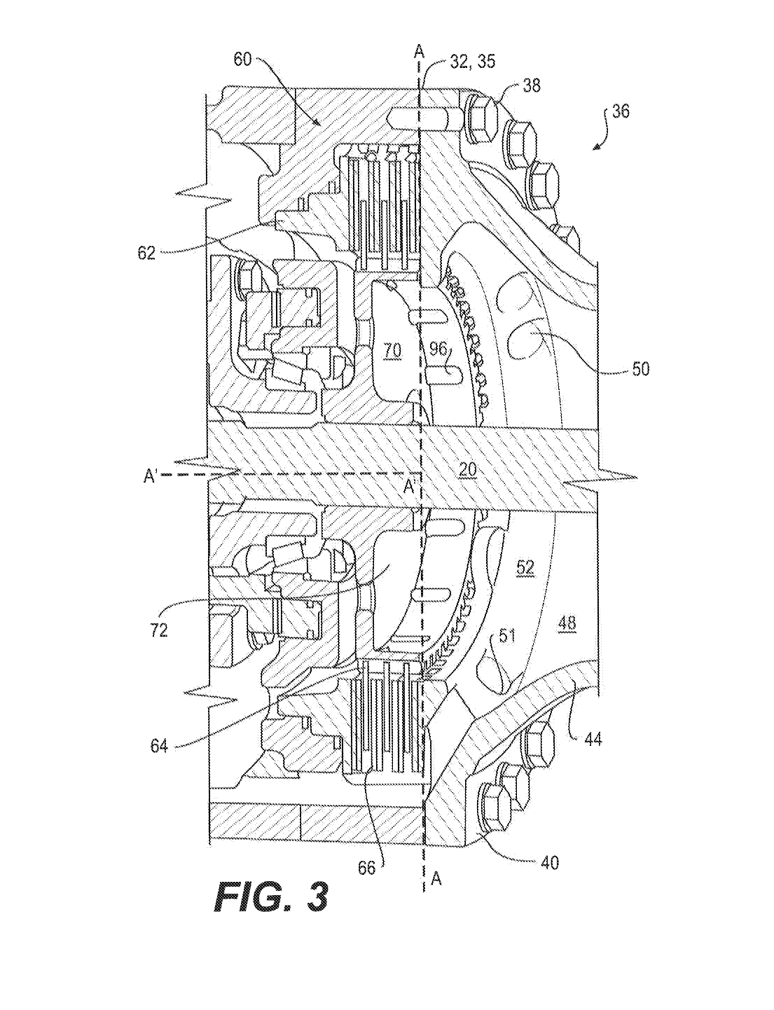

Referring to FIG. 3, mounting flange 36 may include a plurality of conduits 50 that extend from end face 35 toward interior volume 48 of leg housing 34. Conduits 50 may terminate at a beveled annular surface 52 within interior volume 48. In one exemplary embodiment, a pair of conduits SC) are disposed at an assembled two o'clock position of mounting flange 36 (as viewed from an axial end of leg housing 34). In another exemplary embodiment, a pair of conduits 50 may be disposed at an assembled ten o'clock position on mounting flange 36. That is, two pairs of conduits 50 may be symmetrically arranged with respect to reference axis A-A, with one pair of conduits 50 being disposed approximately at the assembled two o'clock position and the remaining pair of conduits 50 approximately disposed at the assembled ten o'clock position. An additional conduit Si may be disposed at an assembled gravitational lower half of mounting flange 36. It is further contemplated that another suitable number of conduits 51 may be disposed at an assembled lower half of mounting flange 36. In one exemplary arrangement, two conduits 51 are included and are symmetrically arranged with respect to reference axis A-A, although another suitable arrangement may alternatively be utilized.

Referring to both FIGS. 2 and 3, drive assembly 10 may be equipped with an internal braking system 60 (i.e., braking system 60 may be at least partially enclosed by center housing 26 and leg housing 34) configured to resist the rotation of output shafts 20, 22. Braking system 60 may include an actuator 62, one or more brake disks 64, and one or more spacer plates 66. Brake disks 64 may be splined on to a brake hub 70, and spacer plates 66 may be splined on to leg housing 34. That is, brake disks 64 may be connected to rotate with output shafts 20, 22 via brake hub 70 that is splined on to output shafts 20, 22 such that, when actuator 62 is acted on by pressurized fluid, brake disks 64 may be sandwiched between alternating spacer plates 66, creating friction that resists the rotation of output shafts 20, 22.

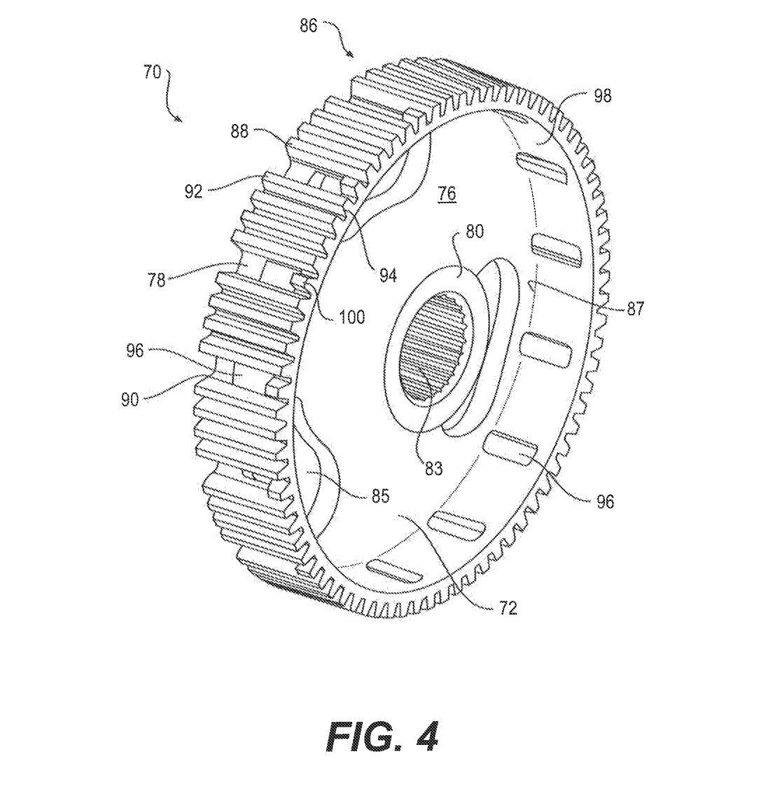

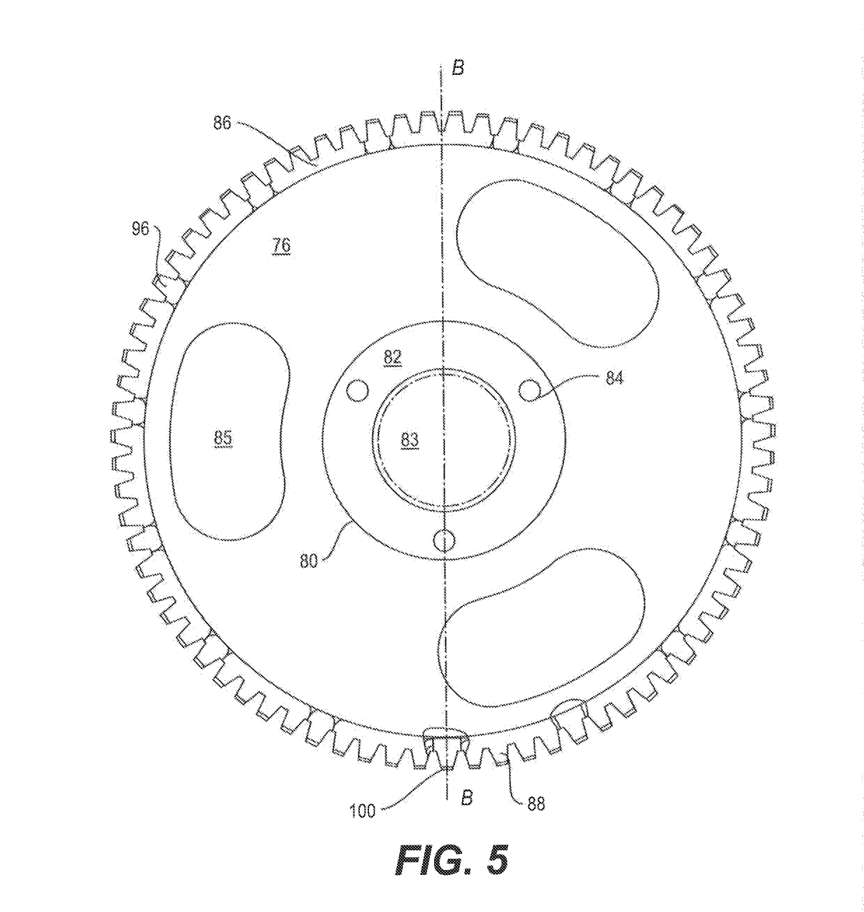

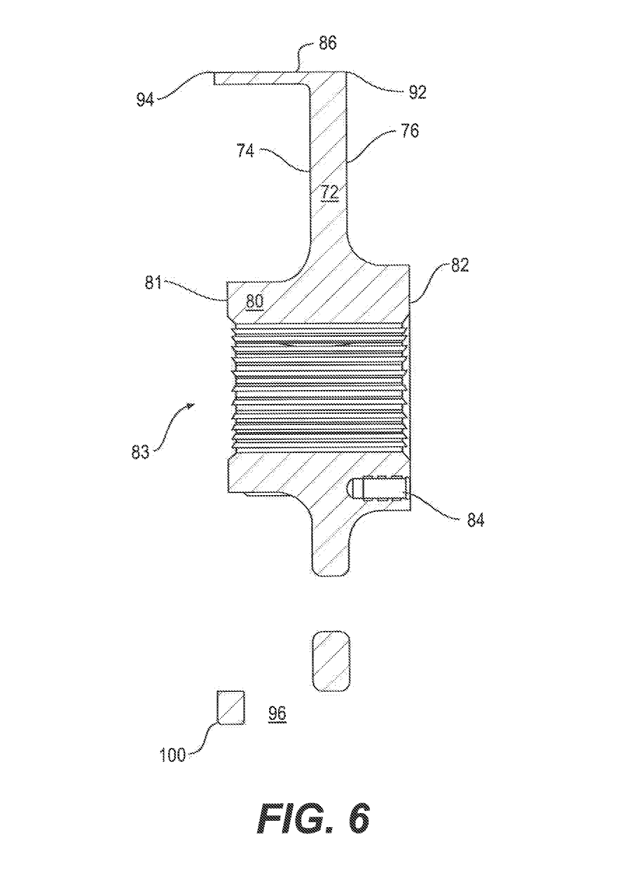

Referring to FIGS. 3-6, brake hub 70 may have a cylindrical body portion 72 with a first end 74, a second end 76, and an outer edge 78. A flange 80 may be disposed at a geometric center of cylindrical body portion 72, and extend outward from first end 74 of cylindrical body portion 72 to terminate at a first end face 81 (referring to FIG. 6). Flange 80 may also extend from second end 76 of cylindrical body portion 72, terminating at a second end face 82. Flange 80 may enclose a center aperture 83 that extends from first end face 81 to second end face 82. A plurality of mounting holes 84 may be formed in second end face 82. Mounting holes 84 may be evenly spaced from one another, or may be arranged in another suitable configuration. In one exemplary embodiment, three mounting holes 84 are disposed on second end face 82 and spaced about 120° from each other. Brake hub 70 may also include axial apertures 85 formed in cylindrical body portion 72. Apertures 85 may be kidney-shaped and evenly spaced, although other suitable shapes and spacing may alternatively be utilized. In one exemplary embodiment, brake hub 70 includes three kidney-shaped apertures 85 spaced about 120° from each other to ensure balanced rotation of brake hub 70.

Brake hub 70 may also include an outer rim 86 that extends from outer edge 78 in a second direction. Cylindrical body portion 72 and outer rim 86 may be generally perpendicular surfaces that meet at a junction 87. A plurality of splines 88 may be disposed on an outer annular surface 90 of outer rim 86 and extend in the second direction from a first end 92 to a second end 94 of outer rim 86. Outer rim 86 may include a plurality of radial apertures 96 that extend from an inner annular surface 98 through outer annular surface 90. An equal number of splines 88 may be disposed between each aperture 96. Apertures 96 may also extend in the second direction, from junction 87 toward second end 94 of outer rim 86. Apertures 96 may extend only partially along outer rim 86, terminating at partial splines 100. Splines 100 may be disposed along outer rim 86, extending from an end of an aperture 96 toward second end 94 of outer rim 86.

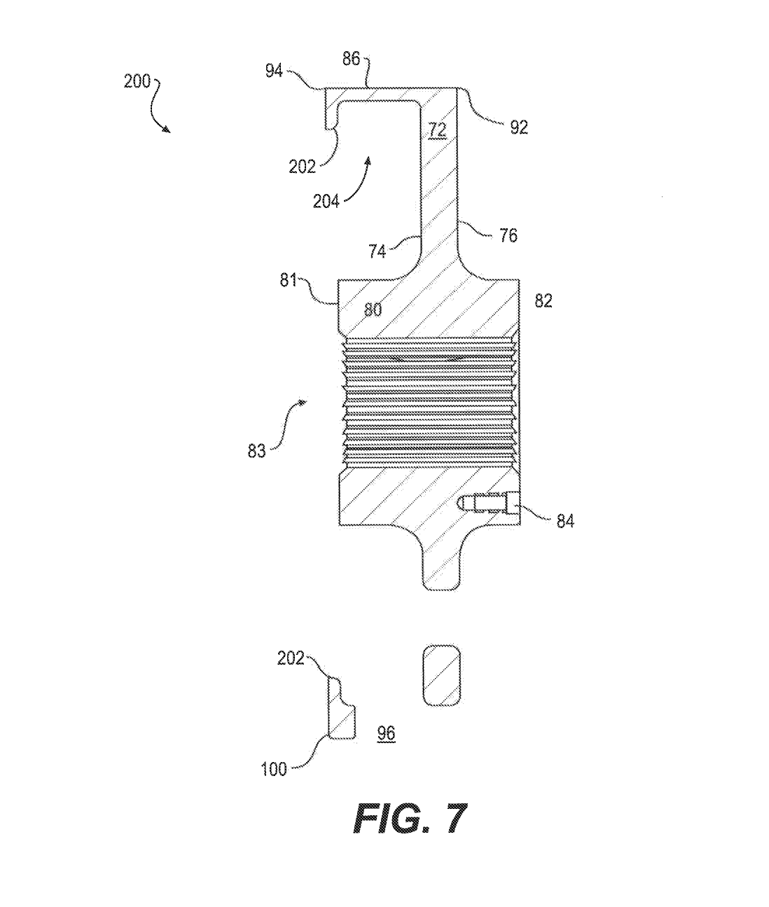

An alternative brake hub 200 is shown in FIG. 7 that is substantially similar to brake hub 70 shown in FIGS. 3-6. Similar to brake hub 70, brake hub 200 may include a cylindrical body portion 72, a flange 80, and an outer rim 86. Additionally, brake hub 200 may include a radially inward protruding lip 202 that extends from second end 94 of outer rim 86, toward a geometric center of brake hub 200. Cylindrical body portion 72, outer rim 86, and lip 202 may generally form an annular recess 204 in communication with each aperture 96.

### INDUSTRIAL APPLICABILITY

The disclosed brake hub may be applicable to any brake system where cooling and longevity of brake disks are an issue. Improved cooling and lubrication of wet brake assemblies may by achieved by using centrifugal force to direct oil through radially located apertures. The rotating components of the disclosed braking system may have an extended useful life because of reduced friction between rotating components. Cooling of braking system 60 will now be described.

Referring to FIG. 3, when a braking event of drive assembly 10 is desired by an operator, the plurality of brake disks 64 may be pushed together by actuator 62, resisting the rotation of output shafts 20 and 22. This braking event may generate friction and heat. To reduce friction and to cool brake disks 64, center housing 26 may be filled with oil up to a fill line A′-A′. Fill line A′-A′ may be located approximately at an assembled gravitational halfway point within center housing 26 (i.e., below conduits 50). While brake hub 70 is rotated in either a forward or reverse direction, centrifugal forces generated by this rotation may direct oil radially outward through apertures 96 and into braking system 60. The oil may then exit braking system 60 and center housing 26 via conduits 50 and 51, carrying heat away from braking system 60. The location of conduits 50 at the assembled two o'clock and ten o'clock positions may facilitate oil flow through braking system 60 during both forward and reverse rotation of brake hub 70. That is, during forward rotation, more oil may flow through the two o'clock conduit, and during reverse rotation, more oil may flow through the ten o'clock conduit. Referring to FIG. 7, during rotation of brake hub 200, the oil directed radially outward may fill recess 204, promoting oil flow toward apertures 96 and allowing brake hub 200 to displace oil at a higher rate.

In one exemplary embodiment, drive assembly 10 may have an oil flow ratio of approximately 0.8-1.2. The oil flow ratio may be defined as the total flow area of apertures 96 compared with the total flow area of conduits 50 and 51. When drive assembly 10 is designed to have an oil flow ratio of approximately 0.8-1.2, a low or zero pressure change may be achieved across drive assembly 10. This ratio may increase an amount of time that oil spends within brake system 60, while simultaneously generating little pressure head in conduits 50 and/or 51. Increased pressure at conduits 50 and/or 51 could trap oil within brake system 60 and increase shearing drag losses.

Brake hubs 70 and 200 may provide improved oil flow and lubrication in braking system 60 by utilizing the centrifugal forces generated during rotation of brake hubs 70 and 200. Operating costs may be reduced because less oil may be required to lubricate and cool braking system 60. The disclosed brake hub may provide a simple and elegant mechanism for cooling a wet brake assembly, and help extend brake disk, spacer, and/or brake hub life by reducing friction and wear of rotating components.

It will be apparent to those skilled in the art that various modifications and variations can be made to the disclosed brake hub without departing from the scope of the disclosure. Other embodiments of the brake hub will be apparent to those skilled in the art from consideration of the specification and practice of the brake hub disclosed herein. It is intended that the specification and examples be considered as exemplary only, with a true scope of the disclosure being indicated by the following claims and their equivalents.

What is claimed is:

1. A brake hub, comprising:
a cylindrical body portion;
a rim extending from an outer edge of the cylindrical body portion, the rim having:
a plurality of first splines disposed on an outer annular surface of the rim, each of the plurality of first splines extending from a first end of the rim to a second end of the rim;
a plurality of radial apertures in the rim extending from the first end of the rim toward the second end of the rim; and
a plurality of second splines disposed on the outer annular surface of the rim, each of the plurality of second splines extending from an edge of one of the plurality of radial apertures to the second end of the rim; and
a mounting flange protruding from the cylindrical body portion.

2. The brake hub of claim 1, wherein the cylindrical body portion includes a plurality of evenly spaced kidney-shaped axial apertures.

3. The brake hub of claim 2, wherein the cylindrical body portion includes three axial apertures spaced about 120° from each other.

4. The brake hub of claim 1, wherein an equal number of first splines are disposed between each of the plurality of radial apertures.

5. The brake hub of claim 1, wherein the mounting flange includes a plurality of internal splines.

6. The brake hub of claim 1, wherein the second end of the rim includes a lip protruding radially inward.

7. The brake hub of claim 6, wherein the cylindrical body portion, the rim, and the lip form an annular recess in communication with each of the plurality of radial apertures

8. A leg housing, comprising:
a body portion having a first end and a second end; and
a flange disposed at the first end;
a first conduit extending from an outer surface of the flange toward an interior volume of the body portion, the first conduit disposed approximately at an assembled two o'clock position of the flange;
a second conduit extending from the outer surface of the flange toward the interior volume of the body portion, the second conduit disposed approximately at an assembled ten o'clock position of the flange; and
a third conduit formed in an assembled gravitational lower half of the flange.

9. The leg housing of claim 8, wherein:
the first conduit is one of a pair of conduits disposed approximately at the assembled two o'clock position of the flange; and
the second conduit is one of a pair of conduits disposed approximately at the assembled ten o'clock position of the flange.

10. The leg housing of claim 8, wherein the third conduit is one of a pair of conduits formed in the assembled gravitational lower half of the flange.

11. A drive assembly, comprising:
a center housing;
a first leg housing connected to an end of the center housing, the leg housing having:
a body portion having a first end and a second end; and
a flange disposed at the first end;
a first conduit extending from an outer surface of the flange toward an interior volume of the body portion, the first conduit disposed approximately at an assembled two o'clock position of the flange;
a second conduit extending from the outer surface of the flange toward the interior volume of the body portion, the second conduit disposed approximately at an assembled ten o'clock position of the flange; and
a third conduit formed in an assembled gravitational lower half of the flange;
an output shaft disposed within the center housing and the leg housing;
a brake hub disposed around the output shaft, the brake hub having:
a cylindrical body portion;
a rim extending from an outer edge of the cylindrical body portion, the rim having:
a plurality of first splines disposed on an outer annular surface of the rim, wherein each of the plurality of first splines extends from a first end of the rim to a second end of the rim;
a plurality of radial apertures in the rim extending from the first end of the rim toward the second end of the rim; and
a plurality of second splines disposed on the outer annular surface of the rim, each of the plurality of second splines extending from an edge of one of the plurality of radial apertures to the second end of the rim; and
a mounting flange protruding from the cylindrical body portion and configured to engage the output shaft.

12. The drive assembly of claim 11, wherein the drive assembly has an oil flow ratio of approximately 0.8 to 1.2.

13. The drive assembly of claim 11 further including a second leg housing connected to the center housing at an end opposite of the first leg housing, the second leg housing being substantially identical to the first leg housing.

14. The drive assembly of claim 11, wherein:
the first conduit is one of a pair of conduits disposed approximately at the assembled two o'clock position of the flange; and
the second conduit is one of a pair of conduits disposed approximately at the assembled ten o'clock position of the flange.

15. The drive assembly of claim 11, wherein the third conduit is one of a pair of conduits formed in the assembled gravitational lower half of the flange.

16. The drive assembly of claim 11, wherein the cylindrical body portion includes a plurality of evenly spaced kidney-shaped axial apertures.

17. The drive assembly of claim 11, wherein an equal number of first splines are disposed between each of the plurality of radial apertures.

18. The drive assembly of claim 11, wherein the mounting flange includes a plurality of internal splines.

19. The drive assembly of claim 11, wherein the second end of the rim includes a lip protruding radially inward.

20. The drive assembly of claim 19, wherein the cylindrical body portion, the rim, and the lip form an annular recess in communication with each of the plurality of radial apertures.
